(19) United States
(12) Patent Application Publication
(10) Pub. No.: US 2005/0121535 A1
(43) Pub. Date: Jun. 9, 2005

(54) Method and device for measuring and regulating the closing and opening times of a piezo control valve

(75) Inventors: Richard Pirkl, Regensburg (DE); Harald Schmidt, Vienna (AT); Harald Gegenfurtner, Scheuer (DE); Walter Schrod, Regensburg (DE)

Correspondence Address: Andreas Grubert;Baker Botts L.L.P., One Shell Plaza, 910 Louisiana, Houston, TX, 77002-4995, US

(73) Assignee: Volkswagen Mechatronic GmbH & Co. KG

(21) Appl. No.: 11/009,980

(22) Filed: Dec. 10, 2004

Related U.S. Application Data
(63) Continuation of application No. PCT/DE03/01858, filed on Jun. 3, 2003.

(30) Foreign Application Priority Data
Jun. 11, 2002 (DE) 102 25 911.9

(51) Int. Cl. B05D 1/00; B05B 17/00; F02D 1/06; A01G 27/00; F16K 31/12

(52) U.S. Cl. 239/5; 239/1; 239/67; 239/70

(57) ABSTRACT

A method and a device for measuring the period of time which the valve needle (50) of a control valve (21) of a piezo pump nozzle unit requires to move from a first end position (64) into a second end position (65) is determined as a function of the voltage (u (t)) which is applied to the control valve (21) and/or the current (i (t)) which is applied. The actuation signal is generated at a time at which it is ensured that the pressure in the control valve (21) corresponds largely to the pressure of the fuel low-pressure region (31) during the measurement.

### CROSS REFERENCE TO RELATED APPLICATION

This application is a continuation of copending International Application No. PCT/DE03/01858 filed Jun. 3, 2003 which designates the United States, and claims priority to German application no. 102 25 911.9 filed Jun. 11, 2002.

### TECHNICAL FIELD OF THE INVENTION

The present invention relates to a method and a device for measuring the period of time which a valve needle of a piezo control valve requires to move from a first end position into a second end position.

### DESCRIPTION OF THE RELATED ART

Piezo control valves are used in piezo pump nozzle units (PPE) for metering quantities of fuel in internal combustion engines. DE 100 38 995 A1 has already disclosed such a PPE. In this PPE, the pump and the nozzle form one unit. The pump is actuated by means of a motor cam shaft, either directly by means of a tappet or indirectly by means of valve lifters. The piezo control valve is actuated by means of an actuation unit in such a way that in a first end position it is completely opened and in a second end position it is completely closed. When the control valve is opened, the fuel is forced back during the piston stroke into the fuel low-pressure region by the pump piston via the piezo control valves. If the control valve closes, the pump piston cannot force the fuel back into the fuel low-pressure region. The fuel is compressed, which leads to an increase in pressure in the high-pressure region of the pump unit. If the pressure in the pump unit exceeds the opening pressure of the injection nozzle, fuel is injected into the combustion chamber of the internal combustion engine. The closing time of the control valve determines the time when the fuel is injected and the closing period of time determines the injection quantity.

The actuation unit of the PPE is composed of a piezo-actuator. The extent of the piezo-actuator is proportional to the voltage (u (t)) which is applied to the piezo-actuator and/or the current (i (t)) which is applied. So that the variation in the injection quantities is as small as possible, the piezo-actuator must be actuated as precisely as possible by a precisely defined voltage (u (t)) and/or a precisely defined current (i (t)) in order to set the start, period and end of the injection process. Wear, aging processes and temperature changes give rise to changed closing times and opening times of the piezo control valve, as a result of which precise control of the injection quantity of fuel is no longer ensured.

DE 199 10 388 C2 discloses a method for checking a capacitive actuator element for satisfactory functioning. The checking of the actuator element is carried out by comparing the period for which the actuator element is activated with the length of the control signal which is responsible for the activation of the actuator element. It is assumed that the actuator element is functioning satisfactorily if the measured period for which the actuator element is activated lies within a region which is determined by the length of the control signal.

### SUMMARY OF THE INVENTION

The invention is based on the object of implementing a method and a device which precisely determine the actual closing and opening times of the control valve. The object can be achieved by a method for measuring a period of time which the valve needle of a control valve of a piezo pump nozzle unit requires, taking into account the response time of the control valve, to move from a first end position into a second end position, comprising the steps of determining the period of time as a function of a voltage and/or a current which are applied to the control valve, generating an actuation signal in order to move the control valve from the first end position into the second end position, and generating the actuation signal at a time at which it is ensured that a pressure in the control valve and in an injection nozzle corresponds largely to a pressure of a fuel low-pressure range during measurement.

The period of time can be measured on a running engine within the period in which a cam shaft is located within its base circle with respect to a pump piston of the injection nozzle or a corresponding transmission elements. The period of time can be measured when a cam shaft is stationary. The fact that the first end position or second end position has been reached can be detected by means of at least one irregularity in the course of the voltage and/or in the current. The first or second end position, can be detected by means of at least one pulse in the profile of the voltage and/or of the current.

The object can also be achieved by a device for measuring a period of time which the valve needle of a control valve of a piezo pump nozzle unit requires to move from a first end position into a second end position taking into account the response time of the control valve, the device comprising a control device comprising the following components: an evaluation unit which determines the period of time as a function of a voltage and/or a current which are applied to the control valve, and a control unit which generates an actuation signal in order to move the control valve from the first end position into the second end position and generates the actuation signal at a time at which it is ensured that a pressure in the control valve and in an injection nozzle corresponds largely to the pressure of a fuel low-pressure region during measurement.

The evaluation unit may comprise a circuit which includes the detection of at least one irregularity or a pulse in the profile of the voltage and/or of the current by evaluating the voltage and/or the current.

The invention is characterized in that the measurement of the actual closing and opening time of the control valve is carried out as a function of the voltage (u (t)) which is applied to the control valve and/or the current (i (t)) which is applied, within the time interval in which the pressure in the control valve corresponds largely to the pressure of the low-pressure region. As a result, the very strong pressure surges which are caused by the hydraulics and which arise when the valve needle closes or opens quickly are avoided. This has a positive effect on the closing and opening behavior of the valve needle. In particular, a stuttering valve needle stroke, caused by the pressure surges, is avoided, allowing the closing and opening times of the control valve to be determined more precisely.

One advantageous refinement of the invention provides for the measurement of the period of time for which the valve needle moves from the one end position into the other end position to be carried out on the running engine, within the period within which the cam shaft is located within its base circle with respect to the pump piston of the injection nozzle or the corresponding transmission elements. In this time, the pump piston of the pump unit remains in its upper end position, and the pressure in the control valve thus corresponds approximately to the pressure in the fuel low-pressure region.

### BRIEF DESCRIPTION OF THE DRAWINGS

A further advantageous refinement of the invention provides for the measurement of the period of time for which the valve needle moves from the one end position into the other end position to be carried out when the cam shaft is stationary (engine off). In this case, the pump piston does not carry any stroke and it is ensured that a movement of the valve needle does not lead to pressure surges within the control valve.

The invention will be explained in more detail below with reference to the drawings, in which:

FIG. 1 is a schematic illustration of a PPE;

FIG. 2 is a piezo control unit for the PPE which is illustrated according to FIG. 1;

FIG. 3 is a schematic illustration of the cam shaft and of the valve lifter for activating the pump piston of the PPE;

FIG. 4 is a graph illustrating the profile of the piezo voltage (u (t)), of the piezo current (i (t)) and of the valve needle stroke (h (t)) for a closing process of the control valve;

FIG. 5 is a further graph illustrating the profile of the piezo voltage (u (t)), of the piezo current (i (t)), of the valve needle stroke (h (t)) and of the piezo charge (q (t)), in particular for an opening process of the control valve; and

FIG. 6 shows a schematic illustration of a flowchart for controlling the closing time of a control valve.

### DETAILED DESCRIPTION OF THE PREFERRED EMBODIMENTS

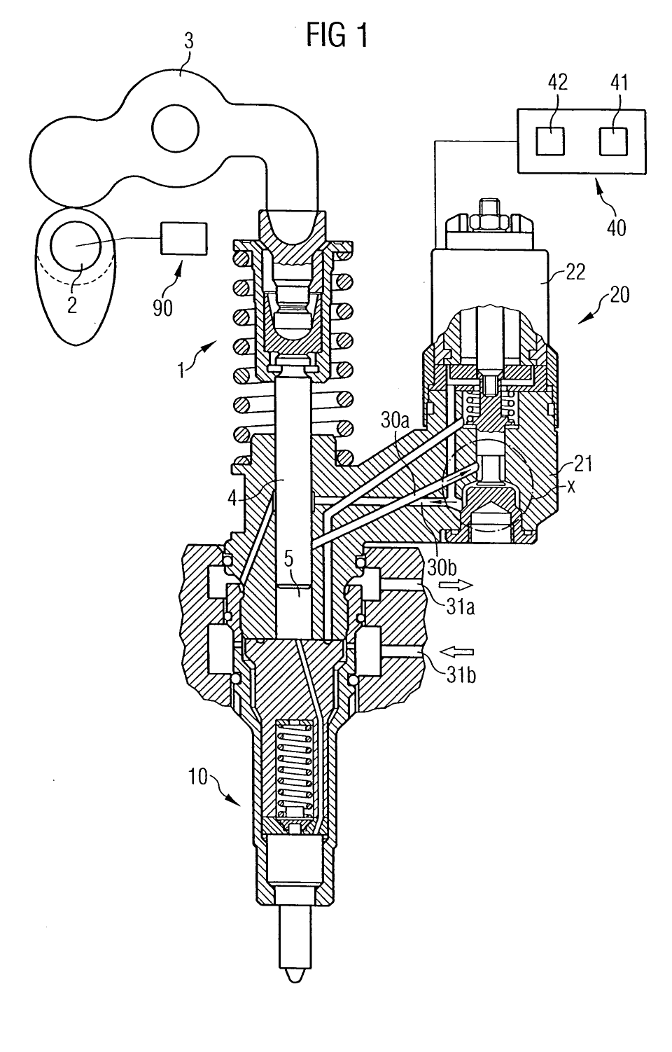

FIG. 1 is a schematic view of a PPE. The PPE which is illustrated is used to feed fuel into the combustion chamber of an internal combustion engine. The PPE has a pump unit 1 which is used to build up the injection pressure. The compressed fuel is injected into the combustion chamber of the internal combustion engine via an injection nozzle 10. Furthermore, the PPE has a piezo actuation unit 20, with a control valve 21 and an externally actuable actuation unit 22. The actuation unit 22 is embodied as a piezo-electric actuator and is connected to the control device 40 which includes an evaluation unit 41 and a control unit 42. The pump unit 1, the injection nozzle 10 and the piezo actuation unit 20 preferably form one unit. The pump unit 1 is driven by the cam shaft 2 directly or, as illustrated, by means of a valve lifter 3. The pump chamber 5 is connected via a bypass bore 30 to the control valve 21 of the piezo actuation unit 20. When the control valve 21 is opened, a free passage between the fuel low-pressure region 31 and the pump chamber 5 is ensured. During the intake stroke of the pump piston 4, fuel can be sucked out of the low-pressure region 31 and through the control valve 21 and the bypass bore 30 and into the pump chamber 5. If the control valve 21 remains opened, the fuel is forced back into the fuel low-pressure part 31 during the subsequent delivery stroke of the pump piston 4, without the fuel being compressed.

If the control valve 21 is closed by means of the externally actuable actuation unit 22 before or during the delivery stroke of the pump piston 4, the fuel in the pump chamber 5 is compressed. If the pressure in the pump chamber 5 exceeds the opening pressure of the injection nozzle 10, the injection nozzle opens and fuel is injected into the combustion chamber of the internal combustion engine.

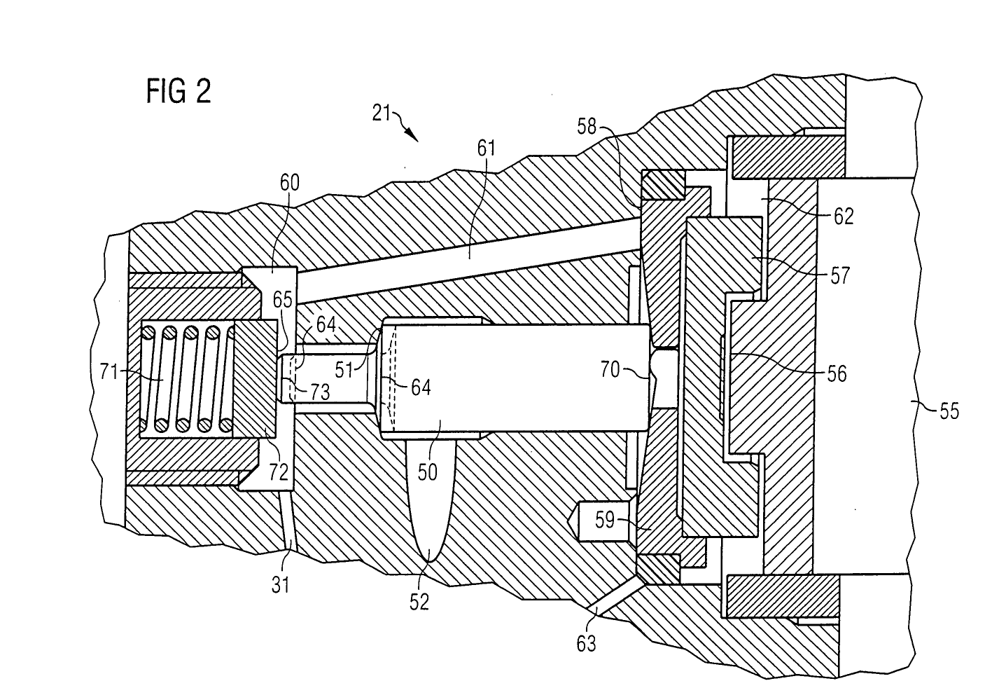

FIG. 2 is a schematic view of a section through a piezo actuation unit 20 which can be used with a PPE according to FIG. 1. The piezo actuation unit 20 has a valve needle 50 which can be moved between a first end position and a second end position. In the first end position 64 of the valve needle 50 (indicated by the dashed lines), the control valve 21 is completely opened and there is a connection between the fuel low-pressure region 31 and the fuel high-pressure region 52. In the second end position 65 (represented by the unbroken lines), the control valve 21 is completely closed. The valve needle 50 is located in the valve seat 51 on the housing and disconnects the fuel low-pressure region 31 from the fuel high-pressure region 52, which is connected to the pump chamber 5 via the bypass bore 30.

The first end position may also be the position in which the control valve 21 is completely closed. The second end position then corresponds to the position in which the control valve 21 is completely opened. The closing or opening time of the control valve 21 is then measured in a way which is analogous to the description in the exemplary embodiments. The valve needle 50 is actuated by means of a piezo-actuator 55. If the piezo-actuator 55 is electrically charged, it expands and transmits a force to the pressure element 57 via the end face 56. The pressure element 57 is in contact with a first lever 58 and a second lever 59. The force, which is transmitted to the pressure element 57 via the piezo-actuator 55, is amplified by means of the levers 58 and 59 and is transmitted to a first axial end face 70 of the valve needle 50. If the force which is generated by the piezo-actuator 55, transmitted via the pressure element 57 and amplified by means of the levers 58 and 59 is greater than a counteracting force, which is transmitted by a spring 71 to a second axial end face 73 of the valve needle 50 via a spring end piece 72, the valve needle 50 is pressed into the valve seat 51. The fuel low-pressure region 31 is connected to the spill chamber 60 which is connected to the actuator chamber 62 via a compensation bore 61. The actuator chamber 62 is itself connected to the return duct 63, via which the fuel can flow out of the actuator chamber 60 and back into the fuel low-pressure region 31.

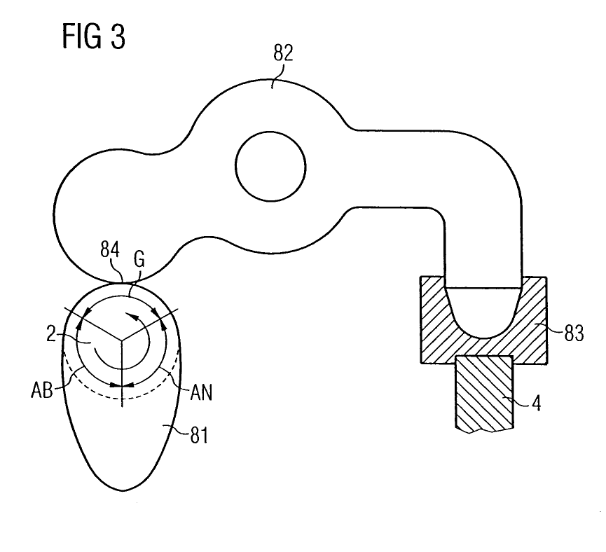

FIG. 3 is a schematic view of an exemplary embodiment for activating the PPE according to FIG. 1. The pump piston 4 is actuated by means of the cam shaft 2 of an internal combustion engine. At each revolution of the cam shaft 2, the cam 81 of the cam shaft 2 activates a valve lifter 82. The valve lifter 82 transmits and amplifies, by virtue of its lever effect, the force from the cam shaft 2 to a transmission element 83 which is in itself in contact with the pump piston 4. Depending on the position of the cam 81 with respect to the valve lifter 82, the pump piston 4 is in an intake stroke, a delivery stroke or remains in its upper initial position between the end of the intake stroke and the start of the delivery stroke. The pump piston 4 carries out a delivery stroke as long as the contact point 84 is located between the valve lifter 82 and cam shaft 2 in the region of the cam leading edge AN. If the contact point 84 lies in the region of the cam trailing edge AB, the pump piston 4 carries out an intake stroke. During the time interval in which the contact point 84 lies in the region of the base circle G, the pump piston 4 remains in its upper initial position. In this time interval, the pressure between the fuel high-pressure region and the fuel low-pressure region is compensated and the valve needle 50 can be moved to and fro between the two end positions without pressure surges being generated in the process. The time interval is therefore particularly suitable for measuring the closing and opening time of the control valve 21.

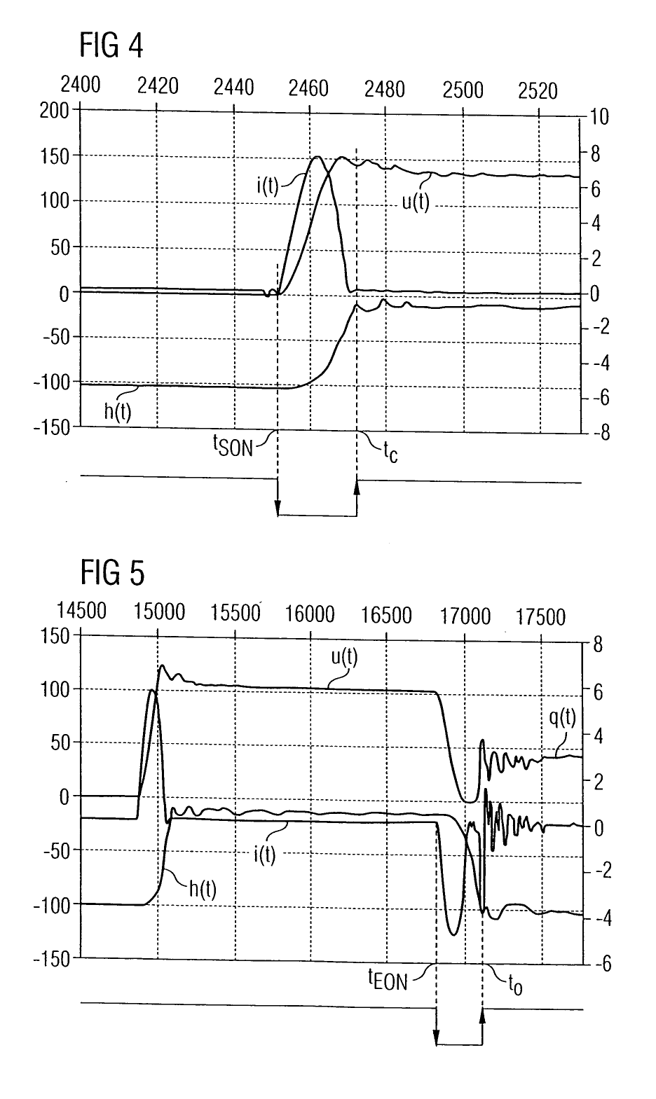

FIG. 4 shows a graph which illustrates the profile of the piezo voltage (u (t)), of the piezo current (i (t)) and of the valve needle stroke (h (t)) for a closing process of the control valve (21). At the time t_{SON} an actuation signal, for example in the form of a standardization pulse SON, which issues the command to close the control valve 21, is set. The valve needle 50 moves from the first end position 64 into the second end position 65 between the time t_{SON} and the time t_{c}. The time interval between t_{SON} and t_{c} thus corresponds precisely to the period of time which the control valve 21 requires from the control command up to complete closure. When the second end position 65 is reached at the time t_{c}, a counteracting force is suddenly generated by the valve needle 50 impacting in the valve seat 51. The counteracting force is passed on via the levers 58 and 59 and the pressure element 57 to the piezo-actuator 55 by means of the mechanical coupling of the valve needle 50, and causes charge carriers to be induced which are apparent as an irregularity in the profile of the piezo voltage (u (t)). The irregularity in the voltage profile can be determined particularly easily by means of the derivative of the piezo voltage (u′ (t)) over time. In order to detect the irregularity in the voltage profile it is suitable, for example, to use an electrical circuit which includes a differentiator with a threshold value detection means connected downstream.

FIG. 5 shows a graph which illustrates the profile of the piezo voltage (u (t)), of the piezo current (i (t)) and of the valve needle stroke (h (t)) and of the piezo charge (q (t)), in particular for an opening process of the control valve 21. At the time t_{EON}, an actuation signal, for example in the form of a standardization pulse EON, which issues the command to open the control valve 21, is set. The valve needle 50 moves from the second end position 65 into the first end position 64 between the time t_{EON} and time tₒ. The time interval between t_{EON} and tₒ thus corresponds precisely to the time which the control valve 21 requires from the control command to complete opening. During the opening process, the piezo-actuator 55 is discharged and in the process returns very quickly into its initial position which is defined for the opening state. The valve needle 50 and the mechanical components which are connected to it cannot follow the piezo-actuator 55 in a frictionally locking fashion and as a result strike the piezo-actuator 55 which is already in its initial position. As a result of the impact, a charge is induced in the piezo-actuator 55 and said charge is detectable as a pulse in the profile of the voltage and/or current. The irregularity may be determined easily, for example by means of a simple detection of threshold values.

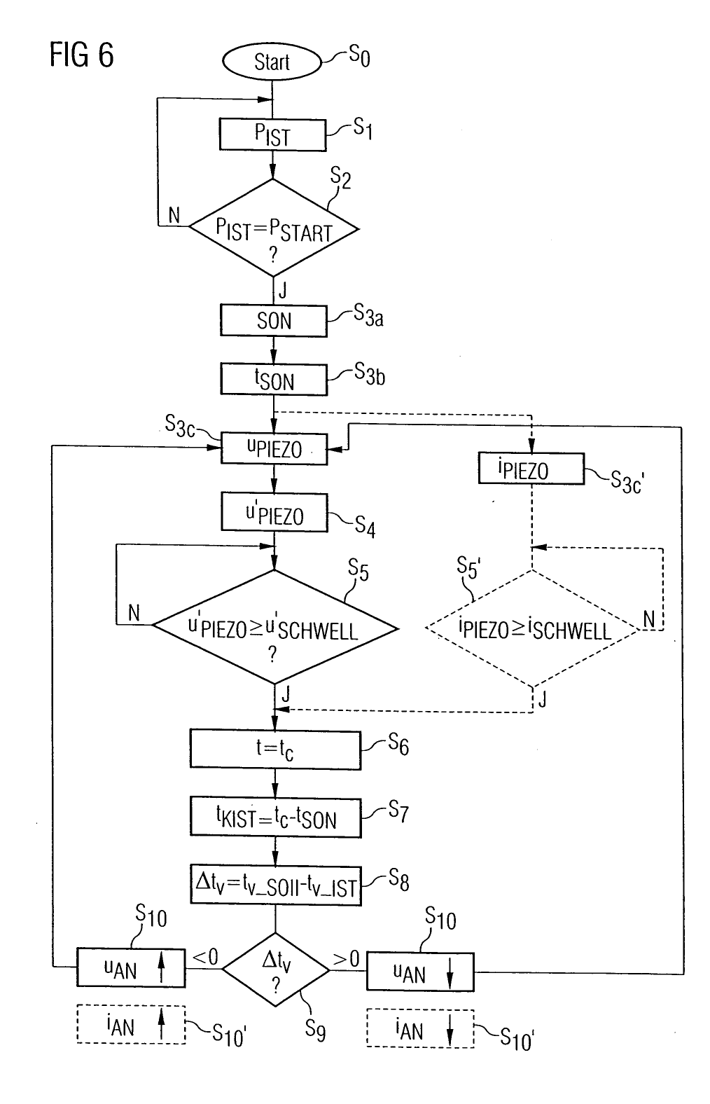

FIG. 6 shows a schematic illustration of a flowchart with respect to regulating the closing time of the control valve 21. The regulating device includes the sensor 90, the control device 40, which has an evaluation unit 41 and a control unit 42, as well as the actuation unit 22. The entire program sequence for regulating the valve closing time and the desired values are stored in the control device 40. The variables which are sensed during the program sequence are evaluated in the evaluation unit 41. The control unit 42 generates the necessary actuation signals for moving the valve needle 50. The intervals in which the closing time measurements are to be carried out may be defined, for example once in each case, at the start of a new operating cycle.

As soon as the program for regulating the valve closing time starts, a measurement firstly takes place in a first step S0, said measurement determining whether the cam shaft 2 is stationary or rotating. When the cam shaft 2 is stationary, the pressure in the control valve 21 and in the injection nozzle 10 largely corresponds to the pressure of the fuel low-pressure region 31 independently of the cam shaft position and the position of the pump piston 4, and the closing process of the control valve 21 can be carried out, as described later starting from step S3a.

If the cam shaft 2 is rotating, in a step S1 the sensor 90 firstly determines the position P_{1ST} in which the cam shaft 2 is located at a particular time. For this purpose, for example a cam shaft rotation-speed sensor can be used as the sensor 90. As an alternative it is also possible to use a position sensor. In a step S2, the instantaneous position P_{1ST} is compared with a stored position P_{START}. In the position P_{START} the cam shaft 2 is preferably located in the vicinity of the cam trailing edge AB with respect to the pump piston 4 within its base circle G. The pump piston 4 is in its upper initial position at this time, and the pressure in the control valve 21 and in the injection nozzle 10 corresponds largely to the pressure of the fuel low-pressure region 31. If P_{1ST} is equal to P_{START}, the measurement of the valve closing time begins. The closing process of the control valve 21 is initiated in step S3a in which a standardization pulse SON, by which the actuation unit 22 is actuated, is set. The time t_{SON} of the actuation is stored in step S3b, and the piezo voltage U_{PIEZO} and/or the piezo current i_{PIEZO} or the actuation energy E_{PIEZO} is applied to the piezo-actuator 55 within the step S3c and/or S3c′. As a result, a charge is generated in the piezo-actuator 55, as a result of which the piezo-actuator 55 expands. The expansion of the piezo-actuator 55 causes the valve needle 50 to start to move from its first end position 64 into its second end position 65.

If the valve needle 50 impacts in the valve seat 51, a force is transmitted to the piezo-actuator 55 by the mechanical coupling of the valve needle 50 to the piezo-actuator 55. The sudden application of force to the piezo-actuator 55 when the valve needle 50 impacts in the valve seat 51, causes a charge to be suddenly induced in the piezo-actuator 55, said charge being proportional to the force acting. Since the force is proportional to the piezo voltage u_{PIEZO} and proportional to the integral of the piezo current ∫i_{PIEZO}, a sudden change in the charge, which is equivalent to the valve needle arriving in the valve seat, can be detected directly by means of the derivative of the piezo voltage u′_{PIEZO} and/or of the piezo current i_{PIEZO}. For this purpose, the derivative of the piezo voltage u′_{PIEZO} is formed during the closing process of the control valve 21 in a step S4, and the profile of the derived piezo voltage u′_{PIEZO} or the profile of the piezo current i_{PIEZO} is compared with a threshold value u′_{SCHWELL} and i_{SCHWELL} in a step S5 and S5′. If the derived voltage u′_{PIEZO} or the current i_{PIEZO} exceeds the corresponding threshold values u′_{SCHWELL} or i_{SCHWELL}, the program detects that the control valve 21 is closed. The time t_{c} at which the threshold value is exceeded and which corresponds to the closing time of the control valve 21 is sensed in a further step S6 and stored. The actual closing time t_{V}_{_{—}}_{1ST} is calculated by subtracting the actuation time t_{SON} from the closing time t_{c} in a step S7. And the closing time difference Δt_{V} is calculated from the actual closing time t_{V}_{_{—}}_{1ST} and a predefined desired closing time t_{V}_{_{—}}_{SOLL} in a further step S8 by subtracting the actual closing time t_{V}_{_{—}}_{1ST} from the desired closing time t_{V}_{_{—}}_{SOLL}. From the closing time difference Δt_{V} it is then possible, in a further step S9, to determine whether too high or too low a value has been selected for the piezo voltage u_{PIEZO} and/or the piezo current i_{PIEZO} or the actuation energy E_{PIEZO} which was applied to the piezo-actuator 55. If Δtᵥ>0, the actual closing time t_{V}_{_{—}}_{1ST} is shorter than the desired closing time t_{V}_{_{—}}_{SOLL}, i.e. the piezo voltage u_{PIEZO} and/or the piezo current i_{PIEZO} or the actuation energy E_{PIEZO} are too high and are reduced in a last step S10. If Δtᵥ<0, the actual closing time t_{V}_{_{—}}_{1ST} is longer than the desired closing time t_{V}_{_{—}}_{SOLL}, i.e. the piezo voltage u_{PIEZO} and/or the piezo current i_{PIEZO} or the actuation energy E_{PIEZO} are too low and are increased in a last step S10. With the readjustment of the piezo voltage u_{PIEZO} and/or the piezo current i_{PIEZO} or the actuation energy E_{PIEZO}, the program run is ended and the valve closing time can be measured again.

1. A method for measuring a period of time which the valve needle of a control valve of a piezo pump nozzle unit requires, taking into account the response time of the control valve, to move from a first end position into a second end position, comprising the steps of:
determining the period of time as a function of a voltage and/or a current which are applied to the control valve,
generating an actuation signal in order to move the control valve from the first end position into the second end position, and
generating the actuation signal at a time at which it is ensured that a pressure in the control valve and in an injection nozzle corresponds largely to a pressure of a fuel low-pressure range during measurement.

2. The method as claimed in claim 1, wherein the period of time is measured on a running engine within the period in which a cam shaft is located within its base circle with respect to a pump piston of the injection nozzle or a corresponding transmission elements.

3. The method as claimed in claim 1, wherein the period of time is measured when a cam shaft is stationary.

4. The method as claimed in claim 1, wherein the fact that the first end position or second end position has been reached is detected by means of at least one irregularity in the course of the voltage and/or in the current.

5. The method as claimed in claim 1, wherein the first or second end position, is detected by means of at least one pulse in the profile of the voltage and/or of the current.

6. A device for measuring a period of time which the valve needle of a control valve of a piezo pump nozzle unit requires to move from a first end position into a second end position taking into account the response time of the control valve, the device comprising a control device comprising the following components:
an evaluation unit which determines the period of time as a function of a voltage and/or a current which are applied to the control valve, and
a control unit which generates an actuation signal in order to move the control valve from the first end position into the second end position and generates the actuation signal at a time at which it is ensured that a pressure in the control valve and in an injection nozzle corresponds largely to the pressure of a fuel low-pressure region during measurement.

7. The device as claimed in claim 6, wherein the evaluation unit comprises a circuit which includes the detection of at least one irregularity or a pulse in the profile of the voltage and/or of the current by evaluating the voltage and/or the current.

8. An arrangement for measuring a period of time which the valve needle of a control valve of a piezo pump nozzle unit requires, taking into account the response time of the control valve, to move from a first end position into a second end position, comprising:
means for determining the period of time as a function of a voltage and/or a current which are applied to the control valve,
means for generating an actuation signal in order to move the control valve from the first end position into the second end position, and for generating the actuation signal at a time at which it is ensured that the pressure in the control valve and in an injection nozzle corresponds largely to the pressure of a fuel low-pressure range during measurement.

9. The arrangement as claimed in claim 8, wherein the period of time is measured on a running engine within the period in which a cam shaft is located within its base circle with respect to a pump piston of the injection nozzle or a corresponding transmission elements.

10. The arrangement as claimed in claim 8, wherein the period of time is measured when a cam shaft is stationary.

11. The arrangement as claimed in claim 8, wherein the fact that the first end position or second end position has been reached is detected by means of at least one irregularity in the course of the voltage and/or in the current.

12. The arrangement as claimed in claim 8, wherein the first or second end position, is detected by means of at least one pulse in the profile of the voltage and/or of the current.
